(19) United States
(12) Patent Application Publication
(10) Pub. No.: US 2007/0002480 A1
(43) Pub. Date: Jan. 4, 2007

(54) DC demagnetization method and apparatus for magnetic recording medium and magnetic transfer method and apparatus

(75) Inventors: Tatsuya Fujinami, Odawara-shi (JP); Makoto Nagao, Odawara-shi (JP); Kazunori Komatsu, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/476,857

(22) Filed: Jun. 29, 2006

(30) Foreign Application Priority Data
Jun. 29, 2005 (JP) 2005-190381
Jun. 29, 2005 (JP) 2005-190382

(51) Int. Cl. G11B 5/86; G11B 5/03

(52) U.S. Cl. 360/17; 360/66

(57) ABSTRACT

According to the present invention, since the applied magnetic field strength is controlled so as to fall between maximum magnetic field strength×0.7 and the maximum magnetic field strength over almost an entire surface of the magnetic recording medium, there is not much variation in the strength of the applied magnetic field relative to media coercivity during DC demagnetization, which makes it possible to obtain uniform magnetization over almost the entire surface.

### BACKGROUND OF THE INVENTION

1. Field of the Invention

The present invention relates to a DC demagnetization method and apparatus for a magnetic recording medium as well as to a magnetic transfer method and apparatus. More particularly, it relates to a DC demagnetization method and apparatus for a magnetic recording medium which are suitable for transferring magnetic information patterns such as format information from a master disk to a magnetic disk used for a hard disk drive and the like and a magnetic transfer method and apparatus which use a magnetic recording medium initialized by the DC demagnetization method.

2. Description of the Related Art

Regarding magnetic disks (hard disks) used for hard disk drives which has sprung into wide use recently, generally format information and address information are written into them after the magnetic disks are delivered from magnetic disk makers to drive makers, but before they are incorporated into the drives. Although the format information and address information can be written using a magnetic head, it is efficient and preferable to transfer them from a master disk in batches.

The magnetic transfer technique consists of bringing a master disk and target disk (slave disk) into close contact, placing a magnetic field generating device such as an electromagnetic device or permanent-magnetic device on one side or both sides of the disks, applying a source magnetic field, and thereby transferring magnetized patterns corresponding to information (e.g., a servo signal) contained in the master disk.

Various magnetic transfer techniques of this type have been proposed so far (e.g., Japanese Patent Application Laid-open No. 2001-28127). Japanese Patent Application Laid-open No. 2001-28127 proposes to set applied magnetic field strength of a source magnetic field at 0.8 to 2 times the coercivity of a slave disk. Reportedly, this is effective in transferring high quality patterns accurately.

Japanese Patent Application Laid-open No. 2002-237031 proposes to increase applied magnetic field strength gradually while rotating a magnetic device and target transfer disk relative to each other. Reportedly, this enables reliable transfer without signal degradation.

### SUMMARY OF THE INVENTION

However, with conventional techniques such as those described in Japanese Patent Application Laid-open Nos. 2001-28127 and 2002-237031, the strength of the applied magnetic field relative to media coercivity on the disk surface varies during DC demagnetization or magnetic transfer, causing a problem of reduction in the C/N ratio of reproduced signals on the target disk.

However, Japanese Patent Application Laid-open No. 2001-28127 and the like provide no guideline for a range of practically acceptable variations in the magnetic field strength, and thus the problem remains unsolved.

On the other hand, Japanese Patent Application Laid-open No. 2002-237031 does not take magnetic viscosity and the number of magnetic field applications into consideration, and thus it is difficult to obtain uniform output over the entire surface of the target disk.

The present invention has been made in view of the above circumstances and has an object to provide a DC demagnetization method and apparatus for a magnetic recording medium which can perform accurate DC demagnetization by specifying an acceptable range of the applied magnetic field strength during DC demagnetization.

Also, the present invention has an object to provide a magnetic transfer method and apparatus which can obtain uniform output over an entire surface of a target disk.

To achieve the above objects, the present invention provides a DC demagnetization method for a magnetic recording medium, comprising: DC-magnetizing the magnetic recording medium circumferentially by applying a magnetic field circumferentially to the magnetic recording medium; and controlling a strength of the magnetic field applied to various parts of the medium such that the strength will fall between maximum magnetic field strength×0.7 and the maximum magnetic field strength over almost an entire surface of the magnetic recording medium.

Also, the present invention provides a DC demagnetization apparatus for a magnetic recording medium, wherein the magnetic recording medium is circumferentially DC-magnetized by applying a magnetic field circumferentially to the magnetic recording medium, and strength of the applied magnetic field is controlled so as to fall between maximum magnetic field strength×0.7 and the maximum magnetic field strength over almost an entire surface of the magnetic recording medium.

According to the present invention, since the applied magnetic field strength is controlled so as to fall between maximum magnetic field strength×0.7 and the maximum magnetic field strength over almost an entire surface of the magnetic recording medium, there is not much variation in the strength of the applied magnetic field relative to media coercivity during DC demagnetization, which makes it possible to obtain uniform magnetization over almost the entire surface.

Also, the present invention provides a DC demagnetization method for a magnetic recording medium, comprising: circumferentially DC-magnetizing the magnetic recording medium whose coercivity depends on application duration of an applied magnetic field, by applying a magnetic field circumferentially to the magnetic recording medium; and applying the magnetic field such that the coercivity will fall between maximum coercivity×0.7 and the maximum coercivity over almost an entire surface of the magnetic recording medium.

According to the present invention, since the magnetic field is applied such that the coercivity will fall between maximum coercivity×0.7 and the maximum coercivity, there is not much variation in the strength of the applied magnetic field relative to media coercivity during DC demagnetization, which makes it possible to obtain uniform magnetization over almost the entire surface.

In the present invention, it is preferable that the application of the magnetic field is performed using a magnetic field generating device while moving the magnetic recording medium relative to the magnetic field generating device and speed fluctuations of the relative movement are kept within ±15%.

If, in this way, the speed fluctuations of the relative movement are kept within ±15%, it is possible to obtain uniform magnetization over almost the entire surface without much variation in the strength of the applied magnetic field relative to media coercivity during DC demagnetization.

Also, in the present invention, it is preferable that the application of the magnetic field is performed using a magnetic field generating device while moving the magnetic recording medium relative to the magnetic field generating device and the magnetic field generating device is approximately equal in length to a radius of the magnetic recording medium and the strength of the magnetic field applied by the magnetic field generating device is increased from inner tracks to outer tracks of the magnetic recording medium.

If, in this way, the strength of the magnetic field applied by the magnetic field generating device is increased from inner tracks to outer tracks of the magnetic recording medium, it is possible to obtain uniform magnetization over almost the entire surface without much variation in the strength of the applied magnetic field relative to media coercivity on almost the entire surface of the magnetic recording medium.

Also, in the present invention, it is preferable that the application of the magnetic field is performed using a magnetic field generating device while moving the magnetic recording medium relative to the magnetic field generating device and the magnetic field generating device is shorter in length than a radius of the magnetic recording medium and the strength of the magnetic field applied by the magnetic field generating device is increased from inner tracks to outer tracks of the magnetic recording medium as the magnetic field generating device moves in a radial direction of the magnetic recording medium.

If, in this way, the strength of the magnetic field applied by the magnetic field generating device is increased from inner tracks to outer tracks of the magnetic recording medium as the magnetic field generating device moves in the radial direction of the magnetic recording medium, it is possible to obtain uniform magnetization over almost the entire surface without much variation in the strength of the applied magnetic field relative to media coercivity on almost the entire surface of the magnetic recording medium.

Also, in the present invention, it is preferable that the application of the magnetic field is performed using a magnetic field generating device while moving the magnetic recording medium relative to the magnetic field generating device and the magnetic field generating device is shorter in length than a radius of the magnetic recording medium and relative rotational speed of the magnetic field generating device in relation to the magnetic recording medium is decreased from inner tracks to outer tracks of the magnetic recording medium as the magnetic field generating device moves in a radial direction of the magnetic recording medium.

If, in this way, the relative rotational speed (relative rotational frequency) of the magnetic field generating device in relation to the magnetic recording medium is decreased from inner tracks to outer tracks as the magnetic field generating device moves in the radial direction of the magnetic recording medium, it is possible to obtain uniform magnetization over almost the entire surface without much variation in the strength of the applied magnetic field relative to media coercivity on almost the entire surface of the magnetic recording medium.

Also, in the present invention, it is preferable that the magnetic field is applied circumferentially to the magnetic recording medium the same number of times in various parts on a surface of the magnetic recording medium.

If, in this way, the magnetic field is applied circumferentially to the magnetic recording medium the same number of times in various parts on a surface of the magnetic recording medium, it is possible to obtain uniform magnetization over almost the entire surface without much variation in media coercivity on almost the entire surface of the magnetic recording medium.

Also, in the present invention, it is preferable that the magnetic field is applied circumferentially to the magnetic recording medium once in each part on the surface of the magnetic recording medium.

If, in this way, the magnetic field is applied circumferentially to the magnetic recording medium once in each part on the surface of the magnetic recording medium, it is possible to obtain uniform magnetization over almost the entire surface without much variation in media coercivity on almost the entire surface of the magnetic recording medium.

Also, in the present invention, it is preferable that on the surface of the magnetic recording medium, part in which the magnetic field is applied circumferentially to the magnetic recording medium a different number of times from the other parts on the surface of the magnetic recording medium does not exceed a circumferential angle of 1 degree.

If, in this way, on the surface of the magnetic recording medium, part in which the magnetic field is applied circumferentially to the magnetic recording medium a different number of times from the other parts does not exceed a circumferential angle of 1 degree, it is possible to obtain uniform magnetization over almost the entire surface without much variation in media coercivity on almost the entire surface of the magnetic recording medium.

Also, in the present invention, it is preferable that in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

The process of applying a magnetic field inevitably involves moving a magnet closer (and then moving it away) if the magnet is a permanent magnet or increasing amperage (and then decreasing it) if an electromagnet is used. The magnetic field applied to the medium at this time is unsteady and desirably its influence is reduced. By increasing rotational speed when increasing the applied magnetic field strength (moving the magnet closer in the case of a permanent magnet or increasing the amperage in the case of an electromagnet), it is possible to increase media coercivity under the influence of magnetic viscosity, decreasing the applied magnetic field strength in a relative sense, and thus reduce the influence of the magnetic field in an unsteady state.

Also, the present invention provides a magnetic transfer method, comprising: an initialization step of initially DC-magnetizing a target magnetic recording medium using the DC demagnetization method for a magnetic recording medium; a joining step of bringing the initially DC-magnetized target magnetic recording medium into close contact with a master medium having a magnetic pattern; and a magnetic transfer step of using a magnetic field generating device, applying a magnetic field circumferentially to the target magnetic recording medium and the master medium while the target magnetic recording medium and the master medium placed in close contact with each other are moved relative to the magnetic field generating device, and thereby transferring the magnetic pattern from the master medium to the target magnetic recording medium.

According to the present, invention, since magnetic transfer is performed using a target magnetic recording medium which is uniformly magnetized over almost the entire surface because there is not much variation in the strength of the applied magnetic field relative to media coercivity during DC demagnetization, it is possible improve the C/N ratio of reproduced signals on the target magnetic recording medium.

To achieve the above objects, the present invention also provides a magnetic transfer method, comprising: a joining step of bringing an initially DC-magnetized target magnetic recording medium into close contact with a master medium having a magnetic pattern; and a magnetic transfer step of using a magnetic field generating device, applying a magnetic field circumferentially to the target magnetic recording medium and the master medium while the target magnetic recording medium and the master medium placed in close contact with each other are moved relative to the magnetic field generating device, and thereby transferring the magnetic pattern from the master medium to the target magnetic recording medium in such a way that strength of the magnetic field applied to various parts of the medium will fall between maximum magnetic field strength×0.7 and the maximum magnetic field strength over almost an entire surface of the magnetic recording medium.

Also, the present invention provides a magnetic transfer apparatus, comprising: a joining device which brings an initially DC-magnetized target magnetic recording medium into close contact with a master medium having a magnetic pattern; and a magnetic transfer device which, using a magnetic field generating device applies a magnetic field circumferentially to the target magnetic recording medium and the master medium while the target magnetic recording medium and the master medium placed in close contact with each other are moved relative to the magnetic field generating device, and thereby transfers the magnetic pattern from the master medium to the target magnetic recording medium in such a way that strength of the magnetic field applied to various parts of the medium will fall between maximum magnetic field strength×0.7 and the maximum magnetic field strength over almost an entire surface of the magnetic recording medium.

According to the present invention, since the strength of the magnetic field applied to various parts of the medium is controlled to fall between maximum magnetic field strength×0.7 and the maximum magnetic field strength over almost the entire surface of the magnetic recording medium, it is possible to perform uniform magnetic transfer over almost the entire surface without much variation in the strength of the applied magnetic field relative to media coercivity during magnetic transfer.

Also, the present invention provides a magnetic transfer method, comprising: a joining step of bringing an initially DC-magnetized target magnetic recording medium whose coercivity depends on application duration of an applied magnetic field into close contact with a master medium having a magnetic pattern; and a magnetic transfer step of using a magnetic field generating device, applying a magnetic field circumferentially to the target magnetic recording medium and the master medium while the target magnetic recording medium and the master medium placed in close contact with each other are moved relative to the magnetic field generating device, and thereby transferring the magnetic pattern from the master medium to the target magnetic recording medium in such a way that the coercivity will fall between maximum coercivity×0.7 and the maximum coercivity over almost an entire surface of the magnetic recording medium.

According to the present invention, since the magnetic field is applied in such a way that the coercivity will fall between maximum coercivity×0.7 and the maximum coercivity over almost the entire surface of the magnetic recording medium, it is possible to perform uniform magnetic transfer over almost the entire surface without much variation in the strength of the applied magnetic field relative to media coercivity during magnetic transfer.

In the present invention, it is preferable that speed fluctuations of the relative movement between the magnetic field generating device and the target magnetic recording medium placed in close contact with the master medium are kept within ±15%.

If, in this way, the speed fluctuations of the relative movement are kept within ±15%, it is possible to perform uniform magnetic transfer over almost the entire surface without much variation in the strength of the applied magnetic field relative to media coercivity during magnetic transfer.

Also, in the present invention, it is preferable that the magnetic field generating device is approximately equal in length to a radius of the target magnetic recording medium and the strength of the magnetic field applied by the magnetic field generating device is increased from inner tracks to outer tracks of the target magnetic recording medium.

If, in this way, the strength of the magnetic field applied by the magnetic field generating device is increased from inner tracks to outer tracks of the target magnetic recording medium, it is possible to perform uniform magnetic transfer over almost the entire surface without much variation in the strength of the applied magnetic field relative to media coercivity during magnetic transfer.

Also, in the present invention, it is preferable that the magnetic field generating device is shorter in length than a radius of the target magnetic recording medium and the strength of the magnetic field applied by the magnetic field generating device is increased from inner tracks to outer tracks of the target magnetic recording medium as the magnetic field generating device moves in a radial direction of the target magnetic recording medium.

If, in this way, the strength of the applied magnetic field is increased from inner tracks to outer tracks of the magnetic recording medium as the magnetic field generating device moves in the radial direction of the target magnetic recording medium, it is possible to perform uniform magnetic transfer over almost the entire surface without much variation in the strength of the applied magnetic field relative to media coercivity during magnetic transfer.

Also, in the present invention, it is preferable that the magnetic field generating device is shorter in length than a radius of the target magnetic recording medium and relative rotational speed of the magnetic field generating device in relation to the target magnetic recording medium and the master medium is decreased from inner tracks to outer tracks of the magnetic recording medium as the magnetic field generating device moves in a radial direction of the target magnetic recording medium.

If, in this way, the relative rotational speed (relative rotational frequency) of the magnetic field generating device in relation to the magnetic recording medium is decreased from inner tracks to outer tracks as the magnetic field generating device moves in the radial direction of the magnetic recording medium, it is possible to perform uniform magnetic transfer over almost the entire surface without much variation in the strength of the applied magnetic field relative to media coercivity.

Also, in the present invention, it is preferable that the magnetic field is applied circumferentially to the target magnetic recording medium and the master medium the same number of times in various parts on a surface of the target magnetic recording medium.

If, in this way, the magnetic field is applied circumferentially to the magnetic recording medium the same number of times in various parts on the surface, it is possible to perform uniform magnetic transfer over almost the entire surface without much variation in media magnetization over almost the entire surface of the magnetic recording medium.

Also, in the present invention, it is preferable that the magnetic field is applied circumferentially to the target magnetic recording medium and the master medium once in each part on the surface of the target magnetic recording medium.

If, in this way, the magnetic field is applied circumferentially to the magnetic recording medium once in each part on the surface, it is possible to perform uniform magnetic transfer over almost the entire surface without much variation in media magnetization over almost the entire surface of the magnetic recording medium.

Also, in the present invention, preferably on the surface of the magnetic recording medium, part in which the magnetic field is applied circumferentially to the target magnetic recording medium and the master medium a different number of times from the other parts on the surface of the target magnetic recording medium does not exceed a circumferential angle of 1 degree.

If, in this way, the part in which the magnetic field is applied circumferentially to the magnetic recording medium a different number of times from the other parts on the surface does not exceed a circumferential angle of 1 degree, it is possible to perform uniform magnetic transfer over almost the entire surface without much variation in media magnetization over almost the entire surface of the magnetic recording medium.

Also, in the present invention, it is preferable that in a preparatory stage of DC magnetic transfer at which the magnetic field strength is raised to a level needed for the DC magnetic transfer or in a termination stage of the DC magnetic transfer at which the magnetic field strength is lowered from the level needed for the DC magnetic transfer, the relative moving speed of the magnetic field generating device in relation to the target magnetic recording medium and the master medium placed in close contact with each other is larger than the relative moving speed of the magnetic field generating device in relation to the target magnetic recording medium and the master medium placed in close contact with each other during the DC magnetic transfer.

The process of applying a magnetic field inevitably involves moving a magnet closer (and then moving it away) if the magnet is a permanent magnet or increasing amperage (and then decreasing it) if an electromagnet is used. The magnetic field applied to the medium at this time is unsteady and desirably its influence is reduced. By increasing rotational speed when increasing the applied magnetic field strength (moving the magnet closer in the case of a permanent magnet or increasing the amperage in the case of an electromagnet), it is possible to increase media coercivity under the influence of magnetic viscosity, decreasing the applied magnetic field strength in a relative sense, and thus reduce the influence of the magnetic field in an unsteady state.

As described above, the present invention makes it possible to obtain uniform magnetization over almost the entire surface without much variation in the strength of the applied magnetic field relative to media coercivity during DC demagnetization.

Also, the present invention makes it possible to perform uniform magnetic transfer over almost the entire surface without much variation in the strength of the applied magnetic field relative to media coercivity or in media magnetization during magnetic transfer.

### BRIEF DESCRIPTION OF THE DRAWINGS

FIG. 1 is a perspective view showing the essence of a magnetic transfer apparatus used to implement a magnetic transfer method according to the present invention;

FIG. 2 is a plane view showing a method for applying a source magnetic field;

FIGS. 3A, 3B, and 3C are diagrams showing basic steps of magnetic transfer;

FIGS. 4A, 4B, and 4C are diagrams showing a magnetic field generating device of another configuration;

FIG. 5 is a perspective view showing an example of a DC demagnetization method;

FIG. 6 is a table showing results of example I-1 and comparative example I-1;

FIG. 7 is a graph showing applied magnetic field strength distribution;

FIG. 8 is a perspective view showing another example of a DC demagnetization method;

FIG. 9 is a graph showing applied magnetic field strength distribution;

FIG. 10 is a perspective view showing yet another example of a DC demagnetization method;

FIG. 11 is a perspective view showing an example of a magnetic transfer method;

FIG. 12 is a table showing results of example II-1 and comparative example II-1; and

FIG. 13 is a perspective view showing another example of a magnetic transfer method.

### DETAILED DESCRIPTION OF THE PREFERRED EMBODIMENTS

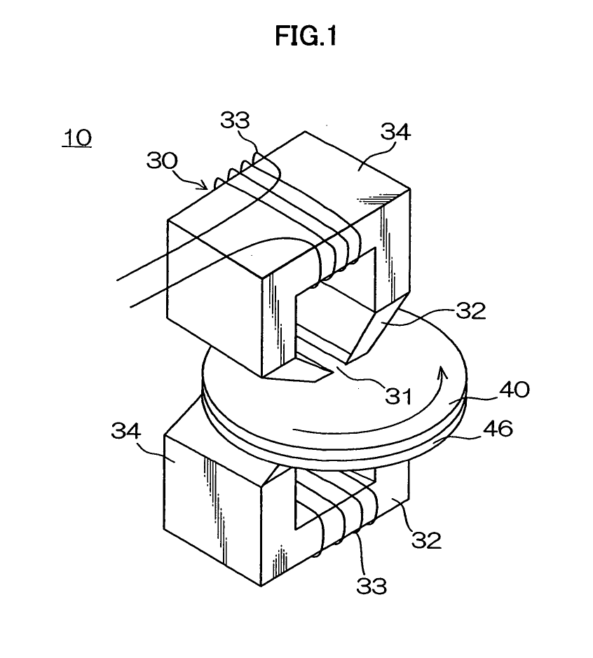

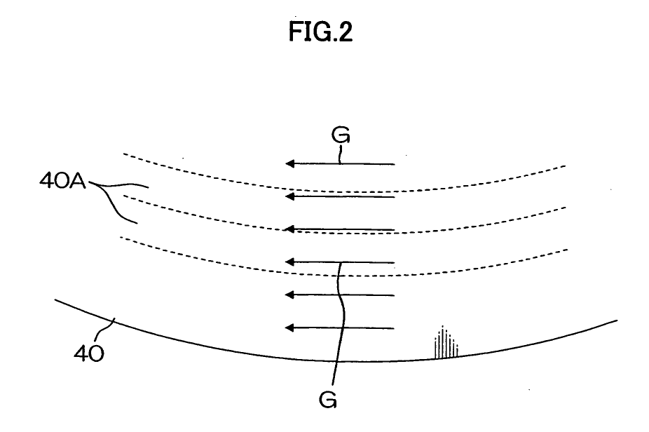

Preferred embodiments of a DC demagnetization method and apparatus for a magnetic recording medium and a magnetic transfer method and apparatus according to the present invention will be described below with reference to the drawings. FIG. 1 is a perspective view showing the essence of a magnetic transfer apparatus 10 used to implement a demagnetization method and apparatus for a magnetic recording medium and a magnetic transfer method according to the present invention. FIG. 2 is a plan view showing a method for applying a source magnetic field.

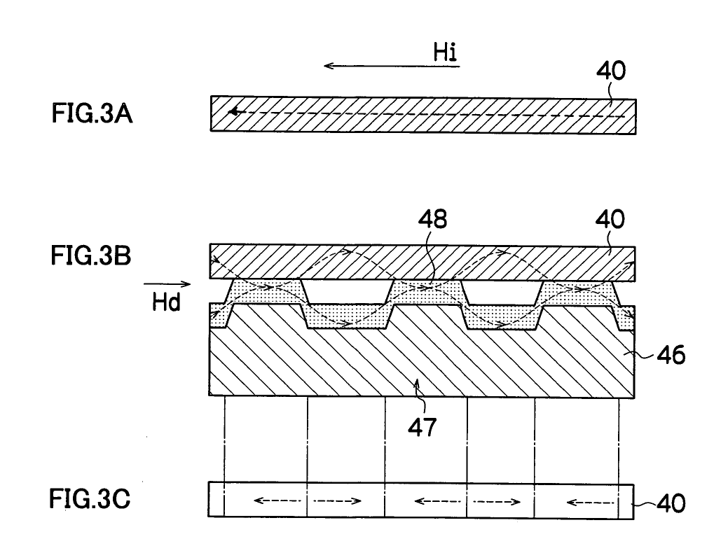

FIGS. 3A, 3B, and 3C are diagrams showing basic steps of the magnetic transfer method, of which FIG. 3A shows a step of initially DC-magnetizing a slave disk 40 which is a target magnetic recording medium by applying a magnetic field in a single direction, FIG. 3B shows a step of applying a magnetic field in the opposite direction by placing a master disk 46 which is a master medium in close contact with the slave disk 40, and FIG. 3C shows a state after magnetic transfer. Incidentally, the figures are schematic diagrams and parts are shown in proportions different from their actual proportions.

With the magnetic transfer apparatus 10 shown in FIG. 1, during magnetic transfer, a slave surface (magnetic recording surface) of the slave disk (target magnetic recording medium) 40 after initial DC magnetization shown in FIG. 3A and described later can be placed in close contact with an information carrying surface of the master disk (master medium) 46 under a predetermined pressure. As a magnetic field generating device 30 applies a source magnetic field with the slave disk 40 placed in close contact with the master disk 46, magnetic patterns such as a servo signal can be transferred and recorded.

The slave disk 40 is a disc-shaped magnetic recording medium such as a hard disk or flexible disk with a magnetic recording layer formed on one or both sides. Before it is placed in close contact with the master disk 46, a cleaning process (burnishing or the like) is performed, as required, to remove microscopic projections or dust by a glide head, abrasive body, or the like. The slave disk 40 undergoes initial magnetization in advance, but details will be described later.

A disc-shaped high-density magnetic recording medium such as a hard disk or flexible disk can be used as the slave disk 40. The magnetic recording layer of the slave disk 40 may be a coating, plating, or thin metal film.

Available magnetic materials for the magnetic recording layer of thin metal film include Co, Co alloy (CoPtCr, CoCr, CoPtCrTa, CoPtCrNbTa, CoCrB, CoNi, etc.), Fe, and Fe alloy (FeCo, FePt, and FeCoNi). For a clear-cut transfer, preferably these materials have high magnetic flux density and magnetic anisotropy in the same direction as the direction of application of the magnetic field (in-plane direction in the case of in-plane recording).

To provide the required magnetic anisotropy, preferably a non-magnetic underlayer is provided under the magnetic material (on the side of a support member). It is necessary to adjust a crystal structure and lattice constant to the magnetic layer. For that, Cr, CrTi, CoCr, CrTa, CrMo, NiAl, or Ru should be used.

The master disk 46 consists of a disc-shaped substrate 47. One of its surfaces is a source information carrying surface provided by a magnetic layer 48 of minute concavo-convex patterns (see FIG. 3B). It is placed in close contact with the slave disk 40. The other surface of the substrate 47 is held by a joining device (not shown).

If the substrate 47 is composed mainly of a ferromagnetic substance such as Ni or the like, magnetic transfer can be carried out with the substrate 47 alone and without any magnetic layer 48, but a magnetic layer 48 with good transfer characteristics will enable better magnetic transfer. If the substrate 47 is made of a non-magnetic substance, it is necessary to provide a magnetic layer 48. Preferably, the magnetic layer 48 of the master disk 46 is a soft magnetic layer with a coercivity Hc of 48 kA/m (approximately 600 Oe).

Materials available for the substrate 47 of the master disk 46 include nickel, silicon, quartz glass or glass of various other compositions, aluminum, alloy, ceramic of various compositions, synthetic resin, and the like. The concavo-convex patterns on the surface of the substrate 47 can be formed by a photofabrication process or a stamper process using an original master produced by the photofabrication process, or the like.

The stamper process involves, for example, forming a photoresist layer on a flat surface of a glass plate (or quartz plate) by spin coating or the like, directing, after prebaking, a laser beam (or electron beam) modulated according to a servo signal at the glass plate which is being rotated, exposing those areas on the disk surface which correspond to frames, and thereby forming predetermined patterns such as concavo-convex patterns corresponding to the servo signal and extending to tracks linearly in the radial direction from the center of rotation on almost the entire surface of the photoresist.

Then, the photoresist layer is developed and the exposed areas are etched away to obtain a glass-made original master on which the concavo-convex patterns are formed by the photoresist layer. The surface of the original master is plated (electroformed) to a predetermined thickness based on the concavo-convex patterns on the glass-made original master to obtain a Ni substrate with positive concavo-convex patterns and the Ni substrate is separated from the original master.

The substrate is used as it is to provide a press master or the concavo-convex patterns are coated with a soft-magnetic layer or protective layer, as required, to provide a press master.

Alternatively, a second original master may be created by plating/electroforming the glass-made original master, and then a reverse original master with negative concavo-convex patterns may be created by plating the second original master. Furthermore, a third original master may be created by plating/electroforming the second original master or by pressing liquid resin onto the second original master and solidifying the resin, and then a substrate with positive concavo-convex patterns may be created by plating/electroforming the third original master.

Available materials for metal substrates include Ni and Ni alloy. Available plating methods for the substrates includes various metal deposition methods such as electroless plating, electroforming, sputtering, and ion plating.

The depth (height of projections) of the concavo-convex patterns on the substrate is preferably between 80 and 800 nm, and more preferably between 100 and 600 nm. In the case of a servo signal, the concavo-convex patterns are elongated in the radial direction. Preferably the radial length is between 0.05 and 20 μm and the circumferential length is between 0.05 and 5 μm. Preferably, patterns with a longer radial dimension are selected within these ranges as patterns which carry information about a servo signal.

The magnetic layer 48 (soft magnetic body) is formed of magnetic material by a vacuum deposition method such as vacuum evaporation, sputtering, or ion plating, or a plating method. Available magnetic materials for the magnetic layer include Co, Co alloy (CoNi, CoNiZr, CoNbTaZr, etc.), Fe, Fe alloy (FeCo, FeCoNi, FeNiMo, FeAlSi, FeAl, FeTaN, etc.), Ni, and Ni alloy (NiFe). Preferable materials are FeCo and FeCoNi. The thickness of the magnetic layer 48 is preferably between 50 nm and 500 nm, and more preferably between 100 nm and 400 nm.

Preferably a protective film of diamond-like carbon or the like is provided on the magnetic layer 48. More preferably, a combination of a diamond-like carbon film 5 to 30 nm thick and a lubricant layer is used as a protective film. A binding layer of Si or the like may be provided between the magnetic layer 48 and the protective film. The lubricant has the effect of preventing reduced durability resulting from damage due to friction caused when correcting misalignment in the process of placing the master disk 46 in contact with the slave disk 40.

A master disk 46 may be created by providing a magnetic layer on a surface of a resin substrate created using the press master. Available materials for the resin substrate include acrylic resins such as polycarbonate and poly methyl methacrylate; vinyl chloride resins such as copolymers of polyvinyl chloride or vinyl chloride; epoxy resins; amorphous polyolefin; and amorphous polyester.

Polycarbonate among them is preferable in terms of humidity resistance, dimensional stability, and costs. Any burrs should be removed from moldings by burnishing or polishing. Alternatively, the press master may be spin-coated or bar-coated using ultraviolet curing resin or electron radiation curing resin to create the master disk 46. The height of the projections in the patterns on the resin substrate is preferably between 50 and 1000 nm, and more preferably between 100 and 500 nm.

The master disk 46 is produced by coating the concavo-convex patterns on the surface of the resin substrate with a magnetic layer 48. The magnetic layer 48 is formed of magnetic material by a vacuum deposition method such as vacuum evaporation, sputtering, or ion plating, or a plating method.

On the other hand, the photofabrication process, one of the methods for creating the master disk 46, involves, for example, applying photoresist on a flat surface of a planar substrate and forming concavo-convex patterns corresponding to information through exposure and developing using a photomask corresponding to a servo signal pattern.

Next, in an etching process, the substrate is etched according to the concavo-convex patterns to produce pits of depth equivalent to the thickness of the magnetic layer 48. Then, magnetic material is deposited to the surface of the substrate, i.e., to a thickness equivalent to the depth of the produced pits, by a vacuum deposition method such as vacuum evaporation, sputtering, or ion plating, or a plating method.

Then, the photoresist is removed by lift-off method and the surface is polished smooth by removing any burrs.

As shown in FIG. 1, magnetic transfer can be carried out either serially by placing a master disk 46, 46 in close contact with one side of the slave disk 40 at a time or simultaneously by placing respective master disks 46′ in close contact with both sides of the slave disk 40 at a time. Incidentally, a cleaning process is performed, as required, to remove dust from the master disk 46 before placing the master disk 46 in close contact with the slave disk 40.

The magnetic field generating device 30 used to apply a source magnetic field has electromagnetic devices 34, 34 placed in upper and lower sides and each consisting of a coil 33 wound around a core 32 which has a gap 31 extending in a radial direction of the slave disk 40 and master disk 46 placed in close contact with each other. It can apply a source magnetic field with lines of magnetic force G (see FIGS. 2 and 3) parallel to the direction of the tracks, in the same direction on the upper and lower sides.

A rotary device is provided to rotate the slave disk 40 and master disk 46 together when the magnetic field generating device 30 applies magnetic fields to magnetically transfer and record information from the master disk 46 to a slave surface of the slave disk 40. Alternatively, the magnetic field generating device 30 may be rotated and moved.

The source magnetic field is generated with such a magnetic field strength distribution that in track directions, there will be no spot with magnetic field strength higher than the upper limit of an optimum range of magnetic field strength (0.6 to 1.3 times the coercivity Hc of the slave disk 40), that there will be at least one spot whose magnetic field strength falls within the optimum range of magnetic field strength in one direction along tracks, and that the magnetic field strength in the opposite direction along the tracks is lower than the lower limit of the optimum range of magnetic field strength in either direction.

Unlike the configuration in FIG. 1, the magnetic field generating device 30 may be placed only on one side of the slave disk 40. Other available configurations (1 to 3) of the magnetic field generating device 30 are listed below.

1) A configuration in which the magnetic field generating device 30 is approximately equal in length (length of a gap 31) to the radius of the slave disk 40 and the applied magnetic field strength of the magnetic field generating device 30 is increased from inner tracks to outer tracks of the slave disk 40.

If, in this way, the applied magnetic field strength of the magnetic field generating device 30 is increased from inner tracks to outer tracks of the slave disk 40, it is possible to obtain uniform magnetization without much variation in the strength of the applied magnetic field relative to media coercivity over almost the entire surface of the slave disk 40.

2) A configuration in which the magnetic field generating device 30 is shorter in length (length of a gap 31) than the radius of the slave disk 40 and the applied magnetic field strength of the magnetic field generating device 30 is increased from inner tracks to outer tracks of the slave disk 40 as the magnetic field generating device 30 moves in a radial direction of the slave disk 40.

If, in this way, the applied magnetic field strength of the magnetic field generating device 30 is increased from inner tracks to outer tracks of the slave disk 40 as the magnetic field generating device 30 moves in a radial direction of the slave disk 40, it is possible to obtain uniform magnetization without much variation in the strength of the applied magnetic field relative to media coercivity over almost the entire surface of the slave disk 40.

3) A configuration in which the magnetic field generating device 30 is shorter in length (length of a gap 31) than the radius of the slave disk 40 and relative rotational speed of the magnetic field generating device 30 in relation to the slave disk 40 is decreased from inner tracks to outer tracks of the slave disk 40 as the magnetic field generating device 30 moves in a radial direction of the slave disk 40.

If, in this way, the relative rotational speed of the magnetic field generating device 30 in relation to the slave disk 40 is decreased from inner tracks to outer tracks of the slave disk 40 as the magnetic field generating device 30 moves in a radial direction of the slave disk 40, it is possible to obtain uniform magnetization without much variation in the strength of the applied magnetic field relative to media coercivity over almost the entire surface of the slave disk 40.

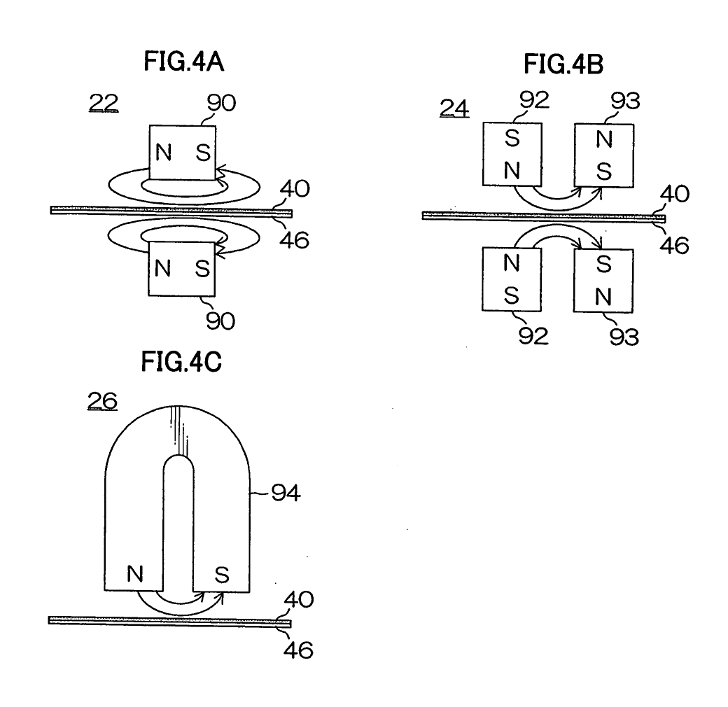

Alternatively, an electromagnet or permanent magnet which generates a source magnetic field may be placed on one or both sides of the slave disk 40 as shown in FIGS. 4A to 4C.

In a magnetic field generating device 22 in FIG. 4A, one electromagnet 90 (or permanent magnet) extends in a radial direction of the slave disk 40 and opposite ends of the electromagnet 90 along the slave surface have opposite polarities to generate a magnetic field along the tracks.

In a magnetic field generating device 24 in FIG. 4B, two parallel electromagnets 92 and 93 (or permanent magnets) are arranged at a predetermined interval along the radius of the slave disk and those ends of the electromagnets 92 and 93 which face the slave surface have opposite polarities to generate a magnetic field along the tracks.

In a magnetic field generating device 26 in FIG. 4C, an electromagnet 94 (or permanent magnet) U-shaped in cross section extends in a radial direction and two ends facing the slave surface have opposite polarities to generate a magnetic field along the tracks.

Next, description will be given of a magnetic transfer method performed by the magnetic transfer apparatus 10 configured as described above.

As shown in FIG. 3A out of FIG. 3 which shows a basic aspect of magnetic transfer, the slave disk 40 is subjected to initial magnetization (DC demagnetization) in advance by the application of an initial magnetic field Hi in one direction along the tracks. The initial magnetization employs a magnetic field with such a magnetic field strength distribution that there will be at least one spot whose magnetic field strength is higher than the coercivity Hc of the slave disk 40 in a track direction—preferably the spots whose magnetic field strength is higher than the coercivity Hc of the slave disk 40 are located only in one direction along the tracks—and that the magnetic field strength in the opposite direction along the tracks is lower than the coercivity Hc of the slave disk 40 in either direction. All the tracks are subjected to initial magnetization (DC demagnetization) by generating such a magnetic field in one part along the tracks and rotating the slave disk 40 or the magnetic field along the tracks.

What is important in carrying out initial magnetization (DC demagnetization) is that the strength of the applied magnetic field is controlled to fall between maximum magnetic field strength×0.7 and the maximum magnetic field strength over almost the entire surface of the slave disk 40. This makes it possible to obtain uniform magnetization over almost the entire surface without much variation in the strength of the applied magnetic field relative to media coercivity during the DC demagnetization.

When the coercivity of the slave disk 40 depends on the application duration of the applied magnetic field, it is important that the coercivity will fall between maximum coercivity×0.7 and the maximum coercivity over almost the entire surface of the slave disk 40. This makes it possible to obtain uniform magnetization over almost the entire surface without much variation in the strength of the applied magnetic field relative to media coercivity during the DC demagnetization.

Preferably speed fluctuations of the relative movement between the slave disk 40 and magnetic field generating device 30 during initial magnetization (DC demagnetization) are kept within ±15%. This makes it possible to obtain uniform magnetization over almost the entire surface without much variation in the strength of the applied magnetic field relative to media coercivity during the DC demagnetization.

Preferably the magnetic field is applied circumferentially to the slave disk 40 the same number of times in various parts on the surface of the slave disk 40. This makes it possible to obtain uniform magnetization over almost the entire surface without much variation in media magnetization over almost the entire surface of the slave disk 40.

Preferably the magnetic field is applied circumferentially to the slave disk 40 once in each part on the surface of the slave disk 40. This makes it possible to obtain uniform magnetization over almost the entire surface without much variation in media magnetization over almost the entire surface of the slave disk 40.

Preferably the part in which the magnetic field is applied circumferentially to the slave disk 40 a different number of times from the other parts does not exceed a circumferential angle of 1 degree. This makes it possible to obtain uniform magnetization over almost the entire surface without much variation in media magnetization over almost the entire surface of the slave disk 40.

After the initial magnetization in FIG. 3A, the information carrying surface consisting of the magnetic layer 48 covering the minute concavo-convex patterns on the substrate 47 of the master disk 46 is placed in close contact with the slave surface (magnetic recording surface) of the slave disk 40 and magnetic transfer is carried out by applying a source magnetic field Hd to the slave disk 40 along the tracks in the direction opposite to the direction of the initial magnetic field Hi, as shown in FIG. 3B.

Consequently, as shown in FIG. 3C, the magnetic patterns corresponding to the patterns of projections and depressions formed on the magnetic layer 48 of the information carrying surface on the master disk 46 are transferred to, and recorded on, the slave surface (tracks) of the slave disk 40 placed in close contact with the projections and depressions.

Incidentally, even if the substrate 47 of the master disk 46 bears negative concavo-convex patterns opposite to the positive concavo-convex patterns shown in FIG. 3, it is possible to transfer and record similar magnetic patterns by reversing the directions of both initial magnetic field Hi and source magnetic field Hd.

Since the magnetic transfer is performed using the slave disk 40 which is uniformly magnetized over almost the entire surface because there is not much variation in the strength of the magnetic field relative to media coercivity or in media magnetization during DC demagnetization, it is possible improve the C/N ratio of reproduced signals on the slave disk 40.

What is important in carrying out the magnetic transfer is that the strength of the applied magnetic field is controlled to fall between maximum magnetic field strength×0.7 and the maximum magnetic field strength over almost the entire surface of the slave disk 40. This makes it possible to perform uniform magnetic transfer over almost the entire surface without much variation in the strength of the applied magnetic field relative to media coercivity during the magnetic transfer.

When the coercivity of the slave disk 40 depends on the application duration of the applied magnetic field, it is important that the coercivity will fall between maximum coercivity×0.7 and the maximum coercivity over almost the entire surface of the slave disk 40. This makes it possible to perform uniform magnetic transfer over almost the entire surface without much variation in the strength of the applied magnetic field relative to media coercivity during the magnetic transfer.

Preferably speed fluctuations of the relative movement between the slave disk 40 and magnetic field generating device 30 during magnetic transfer are kept within ±15%. This makes it possible to perform uniform magnetic transfer over almost the entire surface without much variation in the strength of the applied magnetic field relative to media coercivity during the magnetic transfer.

Preferably the magnetic field is applied circumferentially to the slave disk 40 the same number of times in various parts on the surface of the slave disk 40. This makes it possible to perform uniform magnetic transfer over almost the entire surface without much variation in the strength of the applied magnetic field relative to media coercivity over almost the entire surface of the slave disk 40.

Preferably the magnetic field is applied circumferentially to the slave disk 40 once in each part on the surface of the slave disk 40. This makes it possible to perform uniform magnetic transfer over almost the entire surface without much variation in media magnetization over almost the entire surface of the slave disk 40.

Preferably the part in which the magnetic field is applied circumferentially to the slave disk 40 a different number of times from the other parts does not exceed a circumferential angle of 1 degree. This makes it possible to perform uniform magnetic transfer over almost the entire surface without much variation in media magnetization over almost the entire surface of the slave disk 40.

Since the magnetic transfer is performed uniformly over almost the entire surface without much variation in the strength of the magnetic field relative to applied media coercivity or in media magnetization, it is possible improve the C/N ratio of reproduced signals on the slave disk 40 after the magnetic transfer.

The slave disk 40 can be used suitably by being incorporated into a magnetic recording device (hard disk drive). For this purpose, known hard disk drives put on sale by any drive maker are available.

Embodiments of the DC demagnetization method and apparatus for a magnetic recording medium as well as a magnetic transfer method and apparatus according to the present invention have been described so far, but the present invention is not limited to the above embodiments and can take various forms.

For example, although in the above embodiment, magnetic transfer to the slave disk 40 is performed by the magnetic field generating device 30 while the slave disk 40 is rotated continuously (together with the master disk 46 placed in close contact with it), it is alternatively possible to decrease the magnetic field strength to a predetermined value after the application of a magnetic field to the slave disk 40 and master disk 46 for one or more rounds in the circumferential direction and then stop the rotation of the slave disk 40 and master disk 46.

By decreasing the magnetic field strength to a predetermined value after the application of a magnetic field to the slave disk 40 and master disk 46 for one or more rounds in the circumferential direction and then stopping the rotation of the slave disk 40 and master disk 46, it is possible to reduce influence on the transfer accuracy greatly and improve the C/N ratio of reproduced signals.

### EXAMPLES I

(Production of Slave Disk)

A slave disk 40 was produced under the conditions described below, initial DC magnetization was performed using the magnetic field generating device, and signals transferred to the slave disk 40 was evaluated.

The slave disk 40 was a thin-film hard disk of glass. A 95-mm outside-diameter (3.5 inch type) hard disk with a magnetic layer of CoCrPt 25 nm in film thickness and 5.7 T (4500 Gauss) in flux density Ms was produced using a vacuum deposition apparatus as follows: pressure was reduced to 1.33×10⁻⁵ pa (10⁻⁷ Torr) at room temperature, argon gas was introduced, and a glass plate was heated to 200° C. at 0.4 Pa (3×10⁻⁵ Torr).

### Example I-1 and Comparative Example I-1

(DC Demagnetization Method)

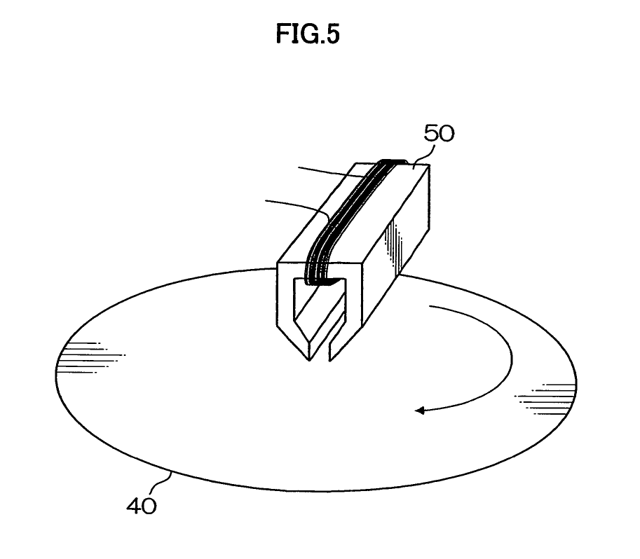

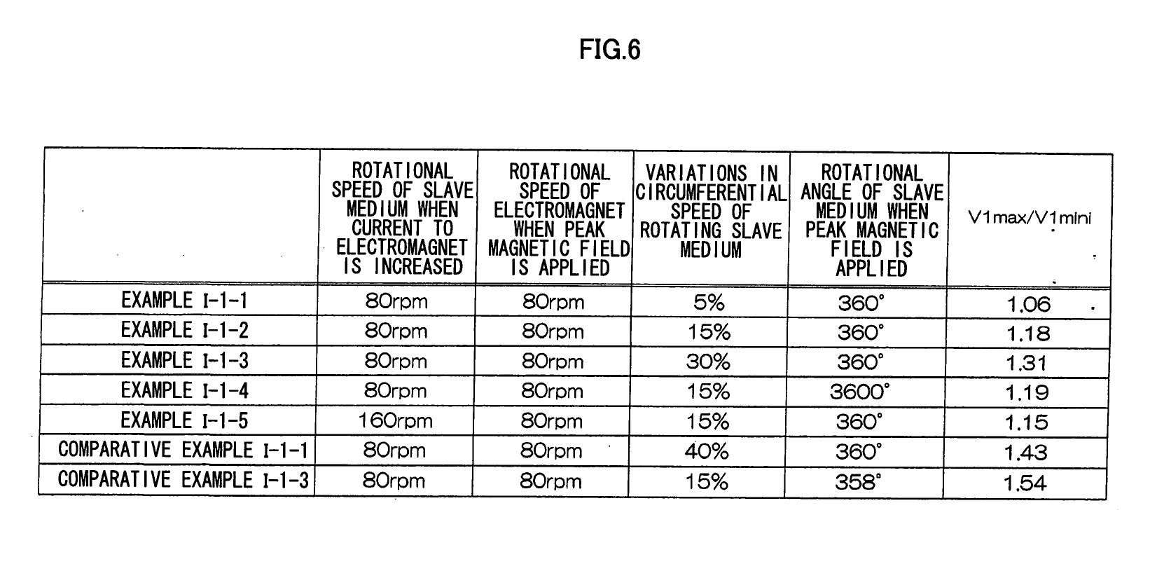

A magnetic field was applied to the slave disk 40 using a device with a permanent magnet 50 placed on one side as shown in FIG. 5. In so doing, amperage of current passed through the permanent magnet 50 was increased as the slave disk 40 was rotated so that peak magnetic field strength would be 397 kA/m (5000 Oe). Conditions under which the magnetic field was applied are shown in a table in FIG. 6.

As shown in the table in FIG. 6, with the rotational frequency of the slave disk 40 kept at 80 rpm (160 rpm in some cases), the amperage was varied so that variations in rotational speed would be between 5% and 40%. Specifically, the amperage was varied in example I-1 so that the variations in rotational speed would be between 5% (example I-1-1) and 30% (example I-1-3) and the amperage was varied in comparative example I-1 so that the variations in rotational speed would be between 15% (comparative example I-1-3) and 40% (comparative example I-1-1).

Also, with the peak magnetic field strength applied, the slave disk 40 was rotated by 360° as a basis, and by different angles in some parts (36000 in example I-1-4 and 358° in comparative example I-1-3).

(Method for Evaluating Electromagnetic Characteristics)

Magnetization of the slave disk 40 was evaluated using an electromagnetic characteristics measuring device (manufactured by Kyodo Electronics Inc.; model number: SS 60). An inductive head with a head gap of 0.32 μm and track width of 3.0 μm was used. The slave disk 40 was measured for one round at a radius of 50 mm and maximum output voltage V_{1MAX} and minimum output voltage V_{1MIN} were determined. Values of V_{1MAX}/V_{1MIN} obtained under the various conditions of magnetic field application are shown in the table in FIG. 6.

As can be seen from the table in FIG. 6, the example gave favorable values of V_{1MAX}/V_{1MIN}, even the largest of which is 1.31. On the other hand, the comparative example gave large values of V_{1MAX}/V_{1MIN}, which are inferior to the results of the example.

### Example I-2 and Comparative Example I-2

(DC Demagnetization Method According to Example I-2)

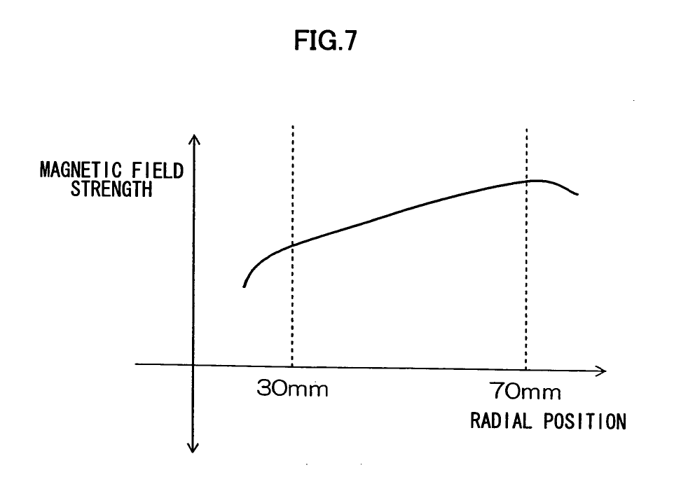

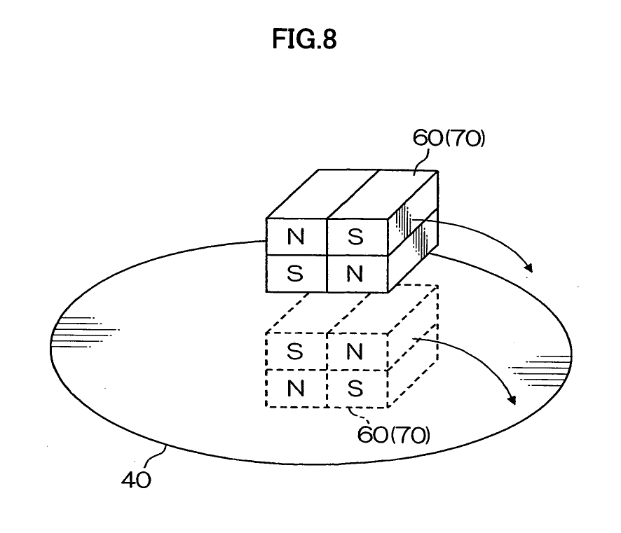

A magnetic field was applied to the slave disk 40 using a device (shown in FIG. 8) which incorporates permanent magnets 60 with a magnetic field strength distribution such as shown in a graph in FIG. 7. The same conditions of magnetic field application as example I-1-2 were used.

As a result, the permanent magnets 60 caused the magnetic field strength to increase linearly along with travel from a radius of 35 mm to a radius of 70 mm on the slave disk 40 as shown in FIG. 7. Incidentally, the permanent magnets 60 were installed on the front and rear sides of the slave disk 40.

(DC Demagnetization Method According to Comparative Example I-2)

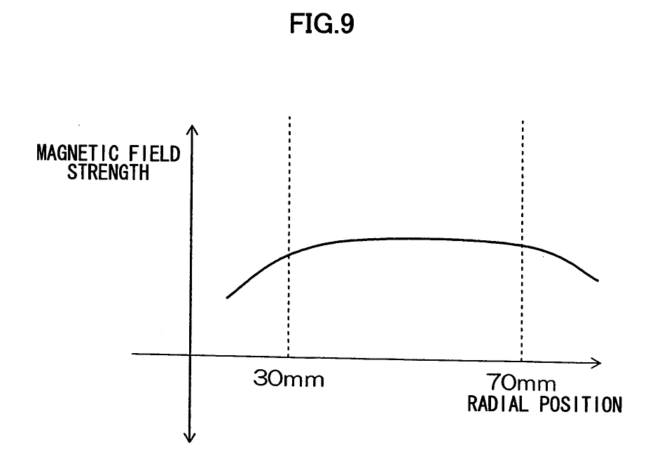

A magnetic field was applied to the slave disk 40 using a device (shown in FIG. 8) which incorporates permanent magnets 70 with a magnetic field strength distribution such as shown in a graph in FIG. 9. The same conditions of magnetic field application as example I-1-2 were used.

As a result, the permanent magnets 70 caused the magnetic field strength to remain almost constant during travel from a radius of 35 mm to a radius of 70 mm on the slave disk 40 as shown in FIG. 9. Incidentally, the permanent magnets 70 were installed on the front and rear sides of the slave disk 40.

(Method for Evaluating Electromagnetic Characteristics)

Signals transferred to the slave disk 40 were evaluated using an electromagnetic characteristics measuring device (manufactured by Kyodo Electronics Inc.; model number: SS 60). An inductive head with a head gap of 0.32 μm and track width of 3.0 μm was used. The slave disk 40 was measured from a radius of 35 mm to a radius of 70 mm at intervals of 1 mm and results were averaged. A ratio V_{2MAX}/V_{2MIN} between maximum value V_{2MAX} and minimum value V_{2MIN} was determined.

The value of V_{2MAX}/V_{2MIN} was 1.14 in example I-2, and 1.50 in comparative example I-2.

### Example I-3 (Examples I-3-1 and I-3-2) and Comparative Example I-3

(DC Demagnetization Method According to Example I-3-1)

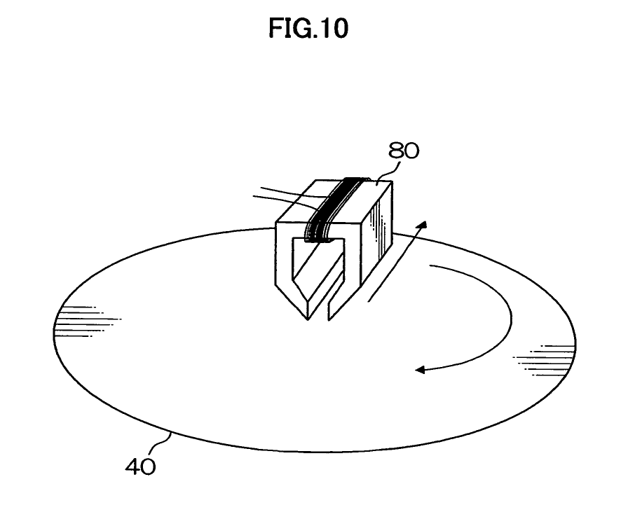

A magnetic field was applied to the slave disk 40 by moving an electromagnet 80 such as shown in FIG. 10 outward from the inner part of the slave disk 40. The following conditions of magnetic field application were used: with the rotational speed of the slave disk 40 kept at 60 rpm, the applied magnetic field strength was set at 358 kA/m (4500 Oe) when the electromagnet 80 was located at a radius of 35 mm, increased gradually as the electromagnet 80 moved toward a radius of 70 mm, and set at 517 kA/m (6500 Oe) when the electromagnet 80 was located at a radius of 70 mm.

(DC Demagnetization Method According to Example I-3-2)

A magnetic field was applied to the slave disk 40 using the electromagnet 80 such as shown in FIG. 10. With the applied magnetic field strength fixed at 557 kA/m (7000 Oe), the electromagnet 80 was moved from a radius of 35 mm toward a radius of 70 mm. The rotational speed of the slave disk 40 was set at 70 rpm when the electromagnet 80 was located at a radius of 35 mm, decreased gradually as the electromagnet 80 moved outward on the slave disk 40, and set at 35 rpm when the electromagnet 80 was located at a radius of 70 mm.

(DC Demagnetization Method According to Comparative Example I-3)

A magnetic field was applied to the slave disk 40 by moving the electromagnet 80 such as shown in FIG. 10 outward from the inner part of the slave disk 40. The following conditions of magnetic field application were used: the rotational speed of the slave disk 40 was kept at 60 rpm and the applied magnetic field strength was fixed at 238 kA/m (3000 Oe).

(Method for Evaluating Electromagnetic Characteristics)

Signals transferred to the slave disk 40 were evaluated using an electromagnetic characteristics measuring device (manufactured by Kyodo Electronics Inc.; model number: SS 60). An inductive head with a head gap of 0.32 μm and track width of 3.0 μm was used. The slave disk 40 was measured from a radius of 35 mm to a radius of 70 mm at intervals of 1 mm and results were averaged. The ratio V_{2MAX}/V_{2MIN} between maximum value V_{2MAX} and minimum value V_{2MIN} was determined.

The value of V_{2MAX}/V_{2MIN} was 1.18 in example I-3-1, 1.06 in example I-3-2, and 1.70 in comparative example I-3.

### Example I-4

(Production of Master Disk for Magnetic Transfer)

A 95-mm outside-diameter (3.5 inch type), disc-shaped master disk 46 for magnetic transfer was produced using a vacuum deposition apparatus as follows: pressure was reduced to 1.33×10⁵ pa (10⁻⁷ Torr) at room temperature, argon gas was introduced, and a FeCo film 200 nm in thickness was formed on a silicon substrate at 0.4 Pa (3×10⁻⁵ Torr). On the master disk 46, 150 radial line patterns were provided at equal intervals (intervals of 2.4°) between radii 35 mm and 70 mm. The coercivity Hc of the master disk 46 was 8 kA/m (100 Oe) and flux density Ms was 28.9 T (23000 Gauss).

(Magnetic Transfer Method)

The slave disk 40 subjected to DC demagnetization in a manner similar to example I-1-1 was placed in close contact with the master disk 46 and a magnetic field was applied in the direction opposite the magnetization of the slave disk 40 using a device with permanent magnets 60 placed on both sides as shown in FIG. 8. Signals transferred to the slave disk 40 were evaluated using an electromagnetic characteristics measuring device (manufactured by Kyodo Electronics Inc.; model number: SS 60) and it was found that good signal quality was obtained.

When the slave disk 40 was incorporated into a magnetic recording device (hard disk drive) commercially available from a drive maker (replacing an existing hard disk) and had its characteristics evaluated, it gave good tracking characteristics.

### EXAMPLES II

(Production of Master Disk for Magnetic Transfer)

A 95-mm outside-diameter (3.5 inch type), disc-shaped master disk 46 for magnetic transfer was produced using a vacuum deposition apparatus as follows: pressure was reduced to 1.33×10⁻⁵ pa (10⁻⁷ Torr) at room temperature, argon gas was introduced, and a FeCo film 200 nm in thickness was formed on a silicon substrate at 0.4 Pa (3×10⁻⁵ Torr). On the master disk 46, 150 radial line patterns were provided at equal intervals (intervals of 2.4°) between radii 35 mm and 70 mm. The coercivity Hc of the master disk 46 was 8 kA/m (100 Oe) and flux density Ms was 28.9 T (23000 Gauss).

[Method for Initial Magnetization (DC Demagnetization)]

A magnetic field was applied to the slave disk 40 using a device with a permanent magnet 50 placed on one side as shown in FIG. 5. Initial DC demagnetization of the slave disk 40 was performed such that the peak magnetic field strength on the surface of the slave disk 40 would be 397 kA/m (5000 Oe).

### Example II-1 and Comparative Example II-1

(Magnetic Transfer Method)

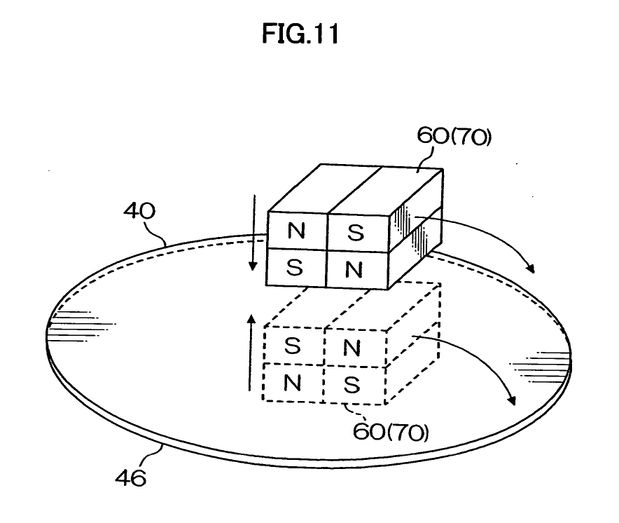

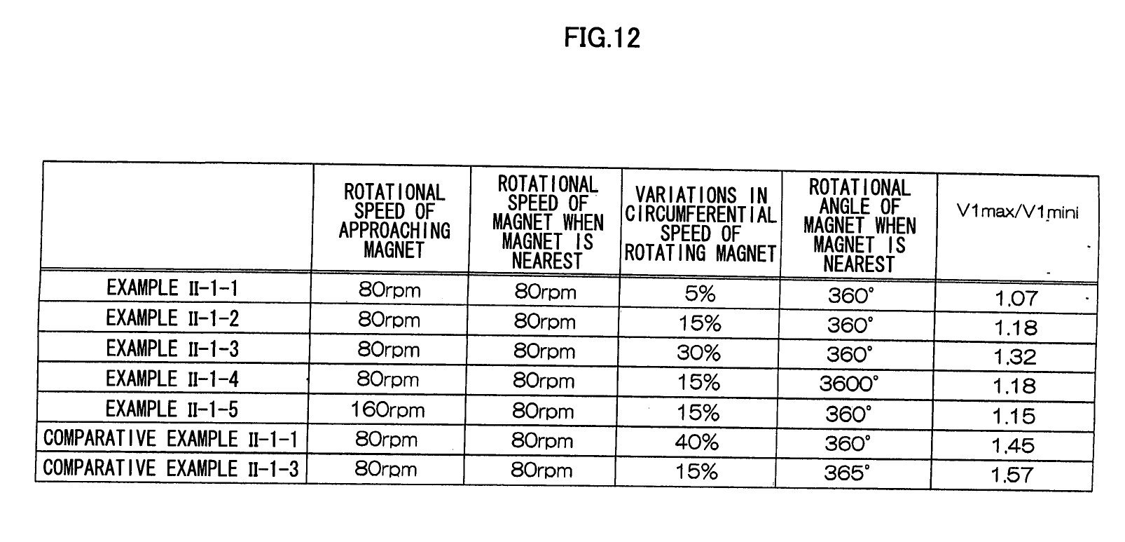

The slave disk 40 subjected to initial DC demagnetization was placed in close contact with the master disk 46 and a magnetic field was applied in the direction opposite the magnetization of the slave disk 40 using a device with permanent magnets 60 placed on both sides as shown in FIG. 11. In so doing, the permanent magnets 60, 60 (shown in FIG. 11) in rotation were brought close to the slave disk 40 such that the peak magnetic field strength when the permanent magnets 60 were nearest to the slave disk 40 would be 238 kA/m (3000 Oe). Other conditions are shown in a table in FIG. 12.

As shown in the table in FIG. 12, with the rotational frequency of the slave disk 40 (master disk 46) kept at 80 rpm (160 rpm in some cases), the magnetic field strength was varied so that variations in rotational speed would be between 5% and 40%. Specifically, the magnetic field strength was varied in example II-1 so that the Variations in rotational speed would be between 5% (example II-1-1) and 30% (example II-1-3) and the magnetic field strength was varied in comparative example II-1 so that the variations in rotational speed would be between 15% (comparative example II-1-3) and 40% (comparative example II-1-1).

Also, with the peak magnetic field strength applied, the slave disk 40 was rotated by 360° as a basis, and by different angles in some parts (3600° in example II-1-4 and 358° in comparative example II-1-3).

(Evaluation of Electromagnetic Characteristics)

Signals transferred to the slave disk 40 were evaluated using an electromagnetic characteristics measuring device (manufactured by Kyodo Electronics Inc.; model number: SS 60). An inductive head with a head gap of 0.32 μm and track width of 3.0 μm was used. The slave disk 40 was measured for one round at a radius of 50 mm and maximum output voltage V_{1MAX} and minimum output voltage V_{1MIN} were determined. Values of V_{1MAX}/V_{1MIN} obtained under the various conditions are shown in the table in FIG. 12.

As can be seen from the table in FIG. 12, the examples gave favorable values of V_{1MAX}/V_{1MIN}, even the largest of which is 1.32. On the other hand, the comparative examples gave large values of V_{1MAX}/V_{1MIN}, which are inferior to the results of the examples.

### Example II-2 and Comparative Example II-2

(Magnetic Transfer Method According to Example II-2)

The slave disk 40 subjected to initial DC demagnetization was placed in close contact with the master disk 46 and a magnetic field was applied in the direction opposite the magnetization of the slave disk 40 using a device (shown in FIG. 11) which has permanent magnets 60 with a magnetic field strength distribution such as shown in a graph in FIG. 7 placed on both sides. The permanent magnets 60 caused the magnetic field strength to increase linearly along with travel from a radius of 35 mm to a radius of 70 mm on the slave disk 40. The same conditions of magnetic field application as example II-1-2 were used.

(Magnetic Transfer Method According to Comparative Example II-2)

The slave disk 40 subjected to initial DC demagnetization was placed in close contact with the master disk 46 and a magnetic field was applied in the direction opposite the magnetization of the slave disk 40 using a device (shown in FIG. 11) which has permanent magnets 70 with a magnetic field strength distribution such as shown in a graph in FIG. 9 placed on both sides. The permanent magnets 70 caused the magnetic field strength to remain almost constant during travel from a radius of 35 mm to a radius of 70 mm on the slave disk 40. The same conditions of magnetic field application as example II-1-2 were used.

(Method for Evaluating Electromagnetic Characteristics)

Signals transferred to the slave disk 40 were evaluated using an electromagnetic characteristics measuring device (manufactured by Kyodo Electronics Inc.; model number: SS 60). An inductive head with a head gap of 0.32 μm and track width of 3.0 μm was used. The slave disk 40 was measured from a radius of 35 mm to a radius of 70 mm at intervals of 1 mm and results were averaged. The ratio V_{2MAX}/V_{2MIN} between maximum value V_{1MAX} and minimum value V_{1MIN} was determined.

The value of V_{2MAX}/V_{2MIN} was 1.13 in example II-2, and 1.50 in comparative example II-2.

### Example II-3 (Examples II-3-1 and II-3-2) and Comparative Example II-3

(Magnetic Transfer Method According to Example II-3-1)

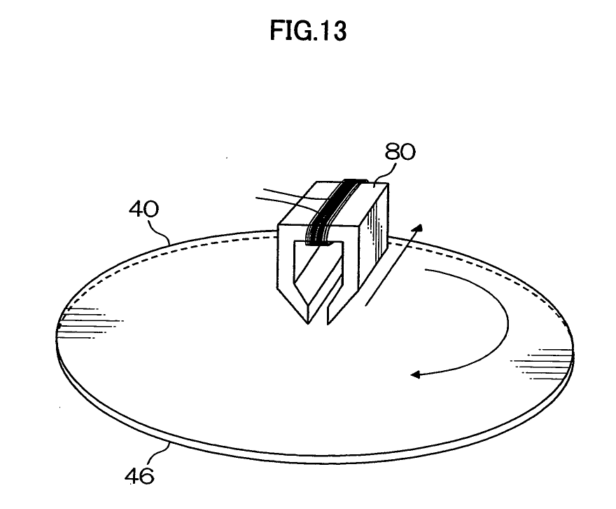

The slave disk 40 subjected to initial DC demagnetization was placed in close contact with the master disk 46 and a magnetic field was applied in the direction opposite the magnetization of the slave disk 40 by moving an electromagnet 80 such as shown in FIG. 13 outward from the inner part of the slave disk 40. The following conditions of magnetic field application were used: with the rotational speed of the slave disk 40 kept at 60 rpm, the applied magnetic field strength was set at 279 kA/m (3500 Oe) when the electromagnet 80 was located at a radius of 35 mm, increased gradually as the electromagnet 80 moved toward a radius of 70 mm, and set at 397 kA/m (5000 Oe) when the electromagnet 80 was located at a radius of 70 mm.

(Magnetic Transfer Method According to Example II-3-2)

The slave disk 40 subjected to initial DC demagnetization was placed in close contact with the master disk 46 and a magnetic field was applied in the direction opposite the magnetization of the slave disk 40 by moving an electromagnet 80 such as shown in FIG. 13 outward from the inner part of the slave disk 40. With the applied magnetic field strength fixed at 297 kA/m (35000 Oe), the electromagnet 80 was moved from a radius of 35 mm toward a radius of 70 mm. The rotational speed of the slave disk 40 was set at 70 rpm when the electromagnet 80 was located at a radius of 35 mm, decreased gradually as the electromagnet 80 moved outward on the slave disk 40, and set at 35 rpm when the electromagnet 80 was located at a radius of 70 mm.

(Magnetic Transfer Method According to Comparative Example II-3).

The slave disk 40 subjected to initial DC demagnetization was placed in close contact with the master disk 46 and a magnetic field was applied in the direction opposite the magnetization of the slave disk 40 by moving an electromagnet 80 such as shown in FIG. 13 outward from the inner part of the slave disk 40.

The following conditions of magnetic field application were used: the rotational speed of the slave disk 40 (master disk 46) was kept at 60 rpm and the applied magnetic field strength was fixed at 238 kA/m (3000 Oe).

(Method for Evaluating Electromagnetic Characteristics)

Magnetization of the slave disk 40 was evaluated using an electromagnetic characteristics measuring device (manufactured by Kyodo Electronics Inc.; model number: SS 60). An inductive head with a head gap of 0.32 μm and track width of 3.0 μm was used. The slave disk 40 was measured from a radius of 35 mm to a radius of 70 mm at intervals of 1 mm and results were averaged. The ratio V_{2MAX}/V_{2MIN} between maximum value V_{2MAX} and minimum value V_{2MIN} was determined.

The value of V_{2MAX}/V_{2MIN} was 1.05 in example II-3-1, 1.06 in example II-3-2, and 1.70 in comparative example II-3.

What is claimed is:

1. A DC demagnetization method for a magnetic recording medium, comprising:
DC-magnetizing the magnetic recording medium circumferentially by applying a magnetic field circumferentially to the magnetic recording medium; and
controlling a strength of the magnetic field applied to various parts of the medium such that the strength will falls between maximum magnetic field strength×0.7 and the maximum magnetic field strength over almost an entire surface of the magnetic recording medium.

2. The DC demagnetization method for a magnetic recording medium according to claim 1, wherein:
the application of the magnetic field is performed using a magnetic field generating device while moving the magnetic recording medium relative to the magnetic field generating device, and
speed fluctuations of the relative movement are kept within ±15%.

3. The DC demagnetization method for a magnetic recording medium according to claim 1, wherein:
the application of the magnetic field is performed using a magnetic field generating device while moving the magnetic recording medium relative to the magnetic field generating device, and
the magnetic field generating device is approximately equal: in length to a radius of the magnetic recording medium and the strength of the magnetic field applied by the magnetic field generating device is increased from inner tracks to outer tracks of the magnetic recording medium.

4. The DC demagnetization method for a magnetic recording medium according to claim 1, wherein:
the application of the magnetic field is performed using a magnetic field generating device while moving the magnetic recording medium relative to the magnetic field generating device, and
the magnetic field generating device is shorter in length than a radius of the magnetic recording medium and the strength of the magnetic field applied by the magnetic field generating device is increased from inner tracks to outer tracks of the magnetic recording medium as the magnetic field generating device moves in a radial direction of the magnetic recording medium.

5. The DC demagnetization method for a magnetic recording medium according to claim 1, wherein:
the application of the magnetic field is performed using a magnetic field generating device while moving the magnetic recording medium relative to the magnetic field generating device, and
the magnetic field generating device is shorter in length than a radius of the magnetic recording medium and relative rotational speed of the magnetic field generating device in relation to the magnetic recording medium is decreased from inner tracks to outer tracks of the magnetic recording medium as the magnetic field generating device moves in a radial direction of the magnetic recording medium.

6. The DC demagnetization method for a magnetic recording medium according to claim 1, wherein the magnetic field is applied circumferentially to the magnetic recording medium the same number of times in various parts on a surface of the magnetic recording medium.

7. The DC demagnetization method for a magnetic recording medium according to claim 1, wherein the magnetic field is applied circumferentially to the magnetic recording medium once in each part on the surface of the magnetic recording medium.

8. The DC demagnetization method for a magnetic recording medium according to claim 1, wherein
on the surface of the magnetic recording medium, part in which the magnetic field is applied circumferentially to the magnetic recording medium a different number of times from the other parts on the surface of the magnetic recording medium does not exceed a circumferential angle of 1 degree.

9. The DC demagnetization method for a magnetic recording medium according to claim 2, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

10. The DC demagnetization method for a magnetic recording medium according to claim 3, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

11. The DC demagnetization method for a magnetic recording medium according to claim 4, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

12. The DC demagnetization method for a magnetic recording medium according to claim 5, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

13. The DC demagnetization method for a magnetic recording medium according to claim 6, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

14. The DC demagnetization method for a magnetic recording medium according to claim 7, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

15. The DC demagnetization method for a magnetic recording medium according to claim 8, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

16. A DC demagnetization method for a magnetic recording medium, comprising:
circumferentially DC-magnetizing the magnetic recording medium whose coercivity depends on application duration of an applied magnetic field, by applying a magnetic field circumferentially to the magnetic recording medium; and
applying the magnetic field such that the coercivity will fall between maximum coercivity×0.7 and the maximum coercivity over almost an entire surface of the magnetic recording medium.

17. The DC demagnetization method for a magnetic recording medium according to claim 16, wherein:
the application of the magnetic field is performed using a magnetic field generating device while moving the magnetic recording medium relative to the magnetic field generating device, and
speed fluctuations of the relative movement are kept within ±15%.

18. The DC demagnetization method for a magnetic recording medium according to claim 16, wherein:
the application of the magnetic field is performed using a magnetic field generating device while moving the magnetic recording medium relative to the magnetic field generating device, and
the magnetic field generating device is approximately equal in length to a radius of the magnetic recording medium and the strength of the magnetic field applied by the magnetic field generating device is increased from inner tracks to outer tracks of the magnetic recording medium.

19. The DC demagnetization method for a magnetic recording medium according to claim 16, wherein:
the application of the magnetic field is performed using a magnetic field generating device while moving the magnetic recording medium relative to the magnetic field generating device, and
the magnetic field generating device is shorter in length than a radius of the magnetic recording medium and the strength of the magnetic field applied by the magnetic field generating device is increased from inner tracks to outer tracks of the magnetic recording medium as the magnetic field generating device moves in a radial direction of the magnetic recording medium.

20. The DC demagnetization method for a magnetic recording medium according to claim 16, wherein:
the application of the magnetic field is performed using a magnetic field generating device while moving the magnetic recording medium relative to the magnetic field generating device, and
the magnetic field generating device is shorter in length than a radius of the magnetic recording medium and relative rotational speed of the magnetic field generating device in relation to the magnetic recording medium is decreased from inner tracks to outer tracks of the magnetic recording medium as the magnetic field generating device moves in a radial direction of the magnetic recording medium.

21. The DC demagnetization method for a magnetic recording medium according to claim 16, wherein the magnetic field is applied circumferentially to the magnetic recording medium the same number of times in various parts on a surface of the magnetic recording medium.

22. The DC demagnetization method for a magnetic recording medium according to claim 16, wherein the magnetic field is applied circumferentially to the magnetic recording medium once in each part on the surface of the magnetic recording medium.

23. The DC demagnetization method for a magnetic recording medium according to claim 16, wherein
on the surface of the magnetic recording medium, part in which the magnetic field is applied circumferentially to the magnetic recording medium a different number of times from the other parts on the surface of the magnetic recording medium does not exceed a circumferential angle of 1 degree.

24. The DC demagnetization method for a magnetic recording medium according to claim 17, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

25. The DC demagnetization method for a magnetic recording medium according to claim 18, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

26. The DC demagnetization method for a magnetic recording medium according to claim 19, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

27. The DC demagnetization method for a magnetic recording medium according to claim 20, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

28. The DC demagnetization method for a magnetic recording medium according to claim 21, wherein
in a preparatory stage of DC demagnetization at which the magnetic field strength is raised to a level needed for the DC demagnetization or: in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

29. The DC demagnetization method for a magnetic recording medium according to claim 22, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

30. The DC demagnetization method for a magnetic recording medium according to claim 23, wherein
in a preparatory stage of DC demagnetization at which the magnetic field strength is raised to a level needed for the DC demagnetization or in a termination stage of the DC demagnetization at which the magnetic field strength is lowered from the level needed for the DC demagnetization, the relative moving speed between the magnetic field generating device and the magnetic recording medium is larger than the relative moving speed between the magnetic field generating device and the magnetic recording medium during the DC demagnetization.

31. A DC demagnetization apparatus for a magnetic recording medium which DC-magnetizes the magnetic recording medium circumferentially by applying a magnetic field circumferentially to the magnetic recording medium, wherein
strength of the magnetic field applied to various parts of the medium is controlled so as to fall between maximum magnetic field strength×0.7 and the maximum magnetic field strength over almost an entire surface of the magnetic recording medium.

32. A magnetic transfer method, comprising:
an initialization step of initially DC-magnetizing a target magnetic recording medium using the DC demagnetization method for a magnetic recording medium according to claim 1;
a joining step of bringing the initially DC-magnetized target magnetic recording medium into close contact with a master medium having a magnetic pattern; and
a magnetic transfer step of using a magnetic field generating device, applying a magnetic field circumferentially to the target magnetic recording medium and the master medium while the target magnetic recording medium and the master medium placed in close contact with each other are moved relative to the magnetic field generating device, and thereby transferring the magnetic pattern from the master medium to the target magnetic recording medium.

33. A magnetic transfer method, comprising:
an initialization step of initially DC-magnetizing a target magnetic recording medium using the DC demagnetization method for a magnetic recording medium according to claim 16;
a joining step of bringing the initially DC-magnetized target magnetic recording medium into close contact with a master medium having a magnetic pattern; and
a magnetic transfer step of using a magnetic field generating device, applying a magnetic field circumferentially to the target magnetic recording medium and the master medium while the target magnetic recording medium and the master medium placed in close contact with each other are moved relative to the magnetic field generating device, and thereby transferring the magnetic pattern from the master medium to the target magnetic recording medium.

34. A magnetic transfer method, comprising:
a joining step of bringing an initially DC-magnetized target magnetic recording medium into close contact with a master medium having a magnetic pattern; and
a magnetic transfer step of using a magnetic field generating device, applying a magnetic field circumferentially to the target magnetic recording medium and the master medium while the target magnetic recording medium and the master medium placed in close contact with each other are moved relative to the magnetic field generating device, and thereby transferring the magnetic pattern from the master medium to the target magnetic recording medium in such a way that strength of the magnetic field applied to various parts of the medium will fall between maximum magnetic field strength×0.7 and the maximum magnetic field strength over almost an entire surface of the magnetic recording medium.

35. The magnetic transfer method according to claim 34, wherein speed fluctuations of the relative movement between the magnetic field generating device and the target magnetic recording medium placed in close contact with the master medium are kept within ±15%.

36. The magnetic transfer method according to claim 34, wherein
the magnetic field generating device is approximately equal in length to a radius of the target magnetic recording medium, and
the strength of the magnetic field applied by the magnetic field generating device is increased from inner tracks to outer tracks of the target magnetic recording medium.

37. The magnetic transfer method according to claim 34, wherein
the magnetic field generating device is shorter in length than a radius of the target magnetic recording medium, and
the strength of the magnetic field applied by the magnetic field generating device is increased from inner tracks to outer tracks of the target magnetic recording medium as the magnetic field generating device moves in a radial direction of the target magnetic recording medium.

38. The magnetic transfer method according to claim 34, wherein
the magnetic field generating device is shorter in length than a radius of the target magnetic recording medium, and
relative rotational speed of the magnetic field generating device in relation to the target magnetic recording medium and the master medium is decreased from inner tracks to outer tracks of the magnetic recording medium as the magnetic field generating device moves in a radial direction of the target magnetic recording medium.

39. The magnetic transfer method according to claim 34, wherein the magnetic field is applied circumferentially to the target magnetic recording medium and the master medium the same number of times in various parts on a surface of the target magnetic recording medium.

40. The magnetic transfer method according to claim 34, wherein the magnetic field is applied circumferentially to the target magnetic recording medium and the master medium once in each part on the surface of the target magnetic recording medium.

41. The magnetic transfer method according to claim 34, wherein on the surface of the magnetic recording medium, part in which the magnetic field is applied circumferentially to the target magnetic recording medium and the master medium a different number of times from the other parts on the surface of the target magnetic recording medium does not exceed a circumferential angle of 1 degree.

42. The magnetic transfer method according to claim 34, wherein
in a preparatory stage of DC magnetic transfer at which the magnetic field strength is raised to a level needed for the DC magnetic transfer or in a termination stage of the DC magnetic transfer at which the magnetic field strength is lowered from the level needed for the DC magnetic transfer, the relative moving speed of the magnetic field generating device in relation to the target magnetic recording medium and the master medium placed in close contact with each other is larger than the relative moving speed of the magnetic field generating device in relation to the target magnetic recording medium and the master medium placed in close contact with each other during the DC magnetic transfer.

43. A magnetic transfer method, comprising:
a joining step of bringing an initially DC-magnetized target magnetic recording medium whose coercivity depends on application duration of an applied magnetic field into close contact with a master medium having a magnetic pattern; and
a magnetic transfer step of using a magnetic field generating device, applying a magnetic field circumferentially to the target magnetic recording medium and the master medium while the target magnetic recording medium and the master medium placed in close contact with each other are moved relative to the magnetic field generating device, and thereby transferring the magnetic pattern from the master medium to the target magnetic recording medium in such a way that the coercivity will fall between maximum coercivity×0.7 and the maximum, coercivity over almost an entire surface of the magnetic recording medium.

44. The magnetic transfer method according to claim 43, wherein speed fluctuations of the relative movement between the magnetic field generating device and the target magnetic recording medium placed in close contact with the master medium are kept within ±15%.

45. The magnetic transfer method according to claim 43, wherein
the magnetic field generating device is approximately equal in length to a radius of the target magnetic recording medium, and
the strength of the magnetic field applied by the magnetic field generating device is increased from inner tracks to outer tracks of the target magnetic recording medium.

46. The magnetic transfer method according to claim 43, wherein
the magnetic field generating device is shorter in length than a radius of the target magnetic recording medium, and
the strength of the magnetic field applied by the magnetic field generating device is increased from inner tracks to outer tracks of the target magnetic recording medium as the magnetic field generating device moves in a radial direction of the target magnetic recording medium.

47. The magnetic transfer method according to claim 43, wherein
the magnetic field generating device is shorter in length than a radius of the target magnetic recording medium, and
relative rotational speed of the magnetic field generating device in relation to the target magnetic recording medium and the master medium is decreased from inner tracks to outer tracks of the magnetic recording medium as the magnetic field generating device moves in a radial direction of the target magnetic recording medium.

48. The magnetic transfer method according to claim 43, wherein the magnetic field is applied circumferentially to the target magnetic recording medium and the master medium the same number of times in various parts on a surface of the target magnetic recording medium.

49. The magnetic transfer method according to claim 43, wherein the magnetic field is applied circumferentially to the target magnetic recording medium and the master medium once in each part on the surface of the target magnetic recording medium.

50. The magnetic transfer method according to claim 43, wherein on the surface of the magnetic recording medium, part in which the magnetic field is applied circumferentially to the target magnetic recording medium and the master medium a different number of times from the other parts on the surface of the target magnetic recording medium does not exceed a circumferential angle of 1 degree.

51. The magnetic transfer method according to claim 43, wherein
in a preparatory stage of DC magnetic transfer at which the magnetic field strength is raised to a level needed for the DC magnetic transfer or in a termination stage of the DC magnetic transfer at which the magnetic field strength is lowered from the level needed for the DC magnetic transfer, the relative moving speed of the magnetic field generating device in relation to the target magnetic recording medium and the master medium placed in close contact with each other: is larger than the relative moving speed of the magnetic field generating device in relation to the target magnetic recording medium and the master medium placed in close contact with each other during the DC magnetic transfer.

52. A magnetic transfer apparatus, comprising:
a joining device which brings an initially DC-magnetized target magnetic recording medium into close contact with a master medium having a magnetic pattern; and
a magnetic transfer device which, using a magnetic field generating device, applies a magnetic field circumferentially to the target magnetic recording medium and the master medium while the target magnetic recording medium and the master medium placed in close contact with each other are moved relative to a magnetic field generating device, and thereby transfers the magnetic pattern from the master medium to the target magnetic recording medium in such a way that strength of the magnetic field applied to various parts of the medium will fall between maximum magnetic field strength×0.7 and the maximum magnetic field strength over almost an entire surface of the magnetic recording medium.
